(19) United States
(12) Patent Application Publication
(10) Pub. No.: US 2004/0117220 A1
(43) Pub. Date: Jun. 17, 2004

(54) Secure system and method for self-management of customer relationship management database

(75) Inventors: Catherine A. Chess, Ossining, NY (US); Sastry S. Duri, Yorktown Heights, NY (US); Paul A. Moskowitz, Yorktown Heights, NY (US); Ronald Perez, Mount Kisco, NY (US); Charles P. Tresser, New York, NY (US)

Correspondence Address: HOFFMAN WARNICK & D'ALESSANDRO, LLC, 3 E-COMM SQUARE, ALBANY, NY, 12207

(73) Assignee: International Business Machines Corporation, Armonk, NY (US)

(21) Appl. No.: 10/317,357

(22) Filed: Dec. 12, 2002

(51) Int. Cl. G06F 17/60

(52) U.S. Cl. 705/7

(57) ABSTRACT

A customer relationship management (CRM) system in which customer data can be dynamically controlled by the customer. The CRM system may reside on a server that is accessible by a plurality of customers of a business and a customer service representative (CSR) of the business, and comprise: a database for storing data for each of the plurality of customers related to interactions with the business; a customer interface that allows each customer to access customer specific data; a data subset identification system that allows the customer to identify a subset of the customer specific data; and a CSR interface that allows the CSR to view only the subset of customer specific data.

### BACKGROUND OF THE INVENTION

1. Technical Field

The present invention relates to data privacy, and more specifically relates to a customer relationship management system that allows a customer to dynamically control the disclosure of private customer specific data.

2. Related Art

The techniques of Customer Relationship Management, CRM, which significantly evolved during the 1990s, are based upon the well-established principles of businesses using information to provide improved customer service, marketing, and sales. The pervasive use of computer databases and information retrieval techniques, along with the growth of the Internet, has enabled CRM to quickly evolve into a necessary tool for most businesses. See for example, “CRM at the Speed of Light,” by Paul Greenberg, McGraw-Hill Professional Publishing, Jan. 17, 2001. Using CRM techniques, companies are able to store and retrieve information on customers such as customer profiles including demographic information, histories of past interactions, and purchases. See for example the U.S. Pat. No. 5,970,469, “System and method for providing shopping aids and incentives to customers through a computer network”; U.S. Pat. No. 6,298,330, “Communicating with a computer based on the offline purchase history of a particular customer”; and U.S. Pat. No. 5,459,306, “Method and system for delivering on demand, individually targeted promotions,” which are hereby incorporated by reference.

Current CRM systems, however, face problems relating to security and privacy in that the information contained in the databases, and access to the databases, is under the control of the companies who own the databases. Accordingly, information about a customer may be freely bought and sold, and the customer has no control over the personal data and transaction history data that is contained in the CRM database.

Part of the problem has been addressed by implementing privacy policy systems that guarantee some level of privacy for the customer. Unfortunately, many limitations exist with respect to privacy policy systems. In particular, most privacy policy systems are relatively static in nature, i.e., privacy policies generally cannot be dynamically changed during interactive sessions, e.g., during a transaction between customer and a merchant. The problem is even worse if the privacy policy is controlled through some third party trusted agent where the underlying assumption often is that the preferences are a static attribute defined in a customer's profile.

Additional problems relating to security exist due to the fact that employees of a company, particularly in a customer relations setting, often have unfettered access to a customer's private information. While such information (e.g., account information, purchase histories, etc.) may be necessary for a customer relation's employee to assist a customer, it creates a significant privacy and security risk.

Accordingly, a need exists for a CRM system that allows a customer to flexibly manage their own data, while providing adequate security measures against employees and other third parties.

### SUMMARY OF THE INVENTION

The present invention address the above-mentioned problems, as well as others, by providing a customer relationship management system that allows the customer to dynamically control customer data when interacting with a third party, such as a business. In a first aspect, the invention provides a customer relationship management (CRM) system, comprising: a database for storing customer data; a customer interface for allowing a customer to access customer specific data; a data disclosure management system for allowing the customer to identify a subset of the customer specific data that can be disclosed to a third party; and a third party interface for allowing a third party to access the subset of customer specific data.

In a second aspect, the invention provides a customer relationship management (CRM) system residing on a server that is accessible by a plurality of customers of a business and a customer service representative (CSR) of the business, comprising: a database for storing data for each of the plurality of customers related to interactions with the business; a customer interface that allows each customer to access customer specific data; a data subset identification system that allows the customer to identify a subset of the customer specific data; and a CSR interface that allows the CSR to view only the identified subset of customer specific data.

In a third aspect, the invention provides a customer relationship management (CRM) method, comprising: providing a database of customer data that is accessible by a plurality of customers of a business and a customer service representative (CSR) of the business; initiating a communication between a customer and the CSR to resolve a customer issue; securely outputting customer specific data to the customer; defining a subset of the customer specific data that the customer wants to release to the CSR to further resolve the customer issue; and securely outputting the subset of customer specific data to the CSR.

### BRIEF DESCRIPTION OF THE DRAWINGS

These and other features of this invention will be more readily understood from the following detailed description of the various aspects of the invention taken in conjunction with the accompanying drawings in which:

FIG. 1 depicts a customer relationship management system in accordance with the present invention.

FIG. 2 depicts an exemplary transaction involving a set of customer data in accordance with the present invention.

The drawings are merely schematic representations, not intended to portray specific parameters of the invention. The drawings are intended to depict only typical embodiments of the invention, and therefore should not be considered as limiting the scope of the invention. In the drawings, like numbering represents like elements.

### DETAILED DESCRIPTION OF THE INVENTION

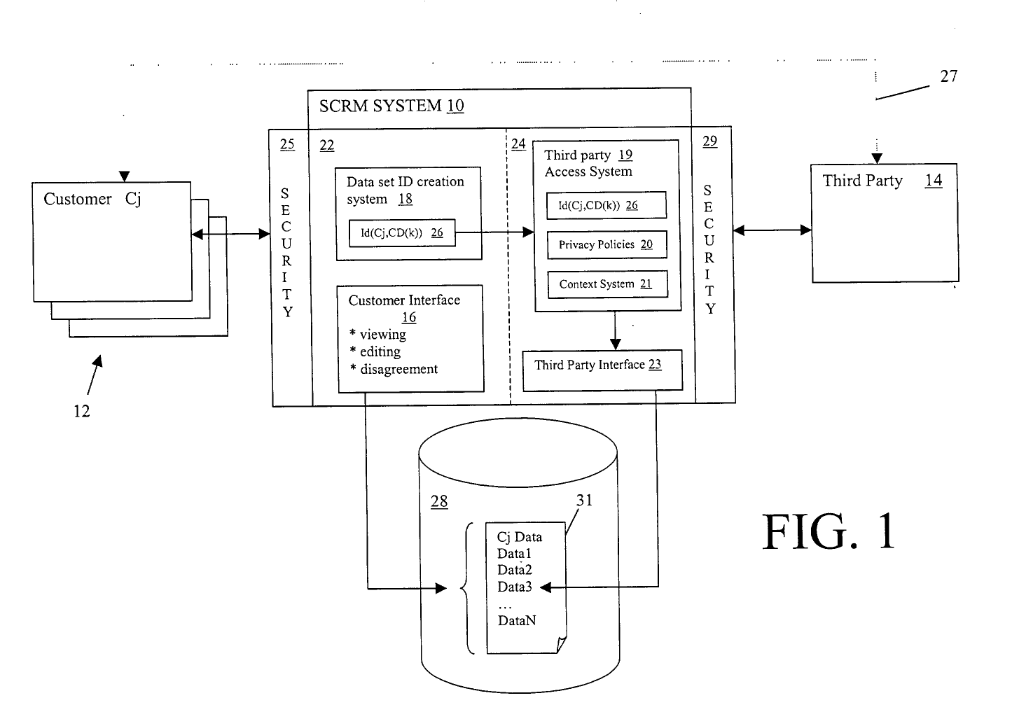

Referring now to the drawings, FIG. 1 depicts a self-managed customer relationship management (SCRM) system 10. SCRM system 10 includes a database 28 for holding customer specific data 31 (e.g., Cj Data) for customers 12 (e.g., Cj) relating to interactions with a third party 14. As described herein, SCRM system 10 enables customers to dynamically control the privacy of their data, and if needed, anonymity of the relation between two parties, such as between a customer and a retailer, bank, insurance company, etc. For the purposes of this disclosure, third party 14 may generally refer to any type of entity that customers 12 interact with, e.g., a business, a merchant, a government entity, etc., and the term “business” may refer to any such entity. In an exemplary embodiment, third party 14 may comprise a customer service representative (CSR) for a merchant that customers 12 transact business with, and database 28 comprises data related to the transactions. It should be understood, however, that the term CSR may comprise any type of representative (human or machine) of an entity.

SCRM system 10 includes various mechanisms that allow both customers 12 and third party 14 to access customer specific data 31. Customer specific data 31 may generally comprise a plurality of data segments (e.g., Data1, Data2 . . . DataN) for a customer. A data segment may comprise any type of data regarding the customer, the third party, or the interactions between the customer and third party 14, e.g., name, address, transaction history, credit history, notes, etc. Moreover, each data segment may comprise a set of data. SCRM system 10 includes security layers 25, 29 using, e.g., secure software, secure protocols (e.g. Diffie-Hellman), cryptographic access (through the use of cryptographic algorithms) and secure hardware, to ensure that, among other things, any party can only access those segments of the database it is entitled to access; any party can only access those computing and data processing tools or resources it is entitled to access; any party can only input and/or edit those segments of the database it is entitled to input and/or edit; any party can post comments for other parties to consider, e.g., about disagreement on the data that corresponds to this party.

Customers 12 access a secure area 22 in SCRM system 10 via security layer 25. Secure area 22 comprises a customer interface 16 that provides each customer 12 with complete access to their own customer specific data 31. Thus, for example, each customer Cj can access his or her portion of database 28 corresponding to interactions with a third party business Bi. The database 28 may be located at the location of or under the direct control of the customer, the business, or a trusted entity. Trusted entities, or trusted intermediaries, are mutually trusted entities that are commonly used to certify or witness transactions between two or more potentially hostile parties in a transaction. Examples include companies such as Verisign (http://www.verisign.com/), a certificate authority and trust services provider, or nonprofit organizations such as TRUSTe (http://www.truste.org/), which provide privacy policy disclosure and attestation services. Another example of trusted third parties is the Key Distribution Center (KDC) in the Kerberos authentication protocol, which is an entity that is trusted with the identification information of all parties on a network/system for the purposes of authenticating resource usage.

Interactions may, for instance, include: identification of customer Cj, including user ID, password, digital signature, digital encryption, customer number, etc., (in some businesses such as banking or for some transactions such as paying taxes, the actual identity of the customer may be required); personal data about Cj, entered by Cj; personal data about Cj, entered by some business Bi, where privacy policy rules would dictate if and how data exchange can be made; a transaction history between Cj, and Bi, where again, privacy policy rules would dictate if and how data exchange can be made; other data and/or accesses to databases. Privacy policy rules may be predefined by an enterprise, in which case the customer may be given a choice of one of several policies that establishes a subset of CRM data that may be conveyed to a business. Alternatively, a customer may be able to construct a policy specifically tailored to that customer's needs by choosing specific instances of data to convey to the business or to suppress. The policy in effect may be changed later dynamically according to the current invention.

In addition, customer interface 16 may include additional functional features such as the ability to edit certain data, e.g., add notes or modify personal information, as well as post disagreements regarding data the customer believes is incorrect. Furthermore, customer interface 16 provides access to a data set ID system 18 for dynamically creating a data set identifier 26 that can be used to define the scope of access that will be afforded to a third party.

Often, a customer may need to disclose some customer specific data to a third party 14 while the two parties communicate via a communication channel 27, such as a telephone call, online chat, email, etc. Data set ID creation system 18 provides a mechanism for the customer to dynamically define the scope of the disclosure. Specifically, each customer can create special data sets relevant to some issue being discussed with, e.g., a customer service representative. In an exemplary embodiment, customer Cj defines some context descriptor CD(k), where k stands for some ordering index, related to Cj or defined in some other way. A data set identifier 26 defined as Id(Cj, CD(k)) is then created and passed to third party access system 19. For instance, Cj may be discussing a invoice with a representative of a business service provider, about which there exists a disagreement over price. Cj can utilize data set ID system to create an identifier that will point to the information in the invoice. In this case, since Cj may simply want to discuss the price discrepancy without revealing his or her identity, Cj may just need to specify an invoice number as the data set identifier.

Third party access system 19 uses the data set identifier, and along with the privacy policies 20 of the customer and context system 21 to define a limited subset of data that can be viewed by the third party. In one embodiment, the subset of data may be constructed so that no description of the identity of Cj appears. Thus, in the case mentioned above, the business representative would be provided only with the contents of the invoice. If it turns out that the wrong price was listed on the invoice, Cj could revise, or provide a new data set identifier that would allow the representative to, for instance, credit Cj's account.

Context system 21 includes a plurality of context rules that are used to resolve any ambiguities in the data set identifier using any known methods, e.g., through assumptions, an interactive dialog, or a defined set of rules, etc. For example, assume a context descriptor is given by a keyword “December.” Context rules may recognize that the customer needs help with all those transactions that took place that month. Moreover, a context rule might assume that “December” refers to transactions in the current year, as opposed to past years. The implementation of such rules engines is well known in the art.

In addition, preset privacy policies 20 may also figure into what subset of data is shown to the third party 14. For example, Cj's privacy policy may require that his or her identity remain anonymous unless Cj gives express authority otherwise. Existing personal policy enforcing products designed that support a user's privacy policy preferences are known in the art and include BRODIAJ, YAHOOJ and AMERICA ONLINEJ. Finally, it may also be preferably to allow the customer to view and edit the subset of data via the customer interface 16, before it is made available to the third party. This will ensure that patterns or hints at private data can be removed from the actual subset of data before the third party views it. For example, if Cj is the only owner of a Rolls Royce in some small town, Cj's identity may be evident to a Rolls Royce service representative by Cj's zip code. Accordingly, Cj may decide to delete the zip code from the subset of data before third party 14 views the subset of Cj's data.

In operation, when a third party 14 needs access to some customer specific data 31 to help resolve a customer issue, third party 14 would enter a secure area 24 via security layer 29. Third party access system 19 determines, as described above, a subset of data that the third party can view via third party interface 23. In the example shown in FIG. 1, the third party is only able to view a single segment “Data3” of Cj Data. Thus, by creating an identifier, e.g., Id(Cj, CD(Data3)), Cj is able to dictate to a third party 14, such as a CSR, that Cj can only view the Data3 subset. If the CSR requires more data, Cj can dynamically modify the identifier to enlarge or alter the subset of data available to the CSR, e.g., Id(Cj, CD(Data3, Data4)).

Because the modification can be done in real time (if necessary), a customer can dynamically control the data being released to third parties. Together, the data set ID system 18 and third party access system 19 create a “data disclosure management system” that is controlled based on inputs from the customer via the customer interface 16. It should understood that the embodiment described in FIG. 1 describes only a single example of how to implement a self managed CRM system, and various modification could be made without departing from the scope of the invention.

It should be understood that SCRM system 10 could reside at a location controlled by a single third party 14 for its own use, or could be set up to service several third party entities (e.g., multiple businesses), in which case the sharing of data between these businesses could be defined so that the customer has control, both of the overall data sharing processes and of individual interactions with each business the customer wants to interact with. In either case, SCRM system 10 may be implemented as a server in a client-server environment using known computing techniques. Alternatively, some or all of the functionality of SCRM system 10 could reside with the customer.

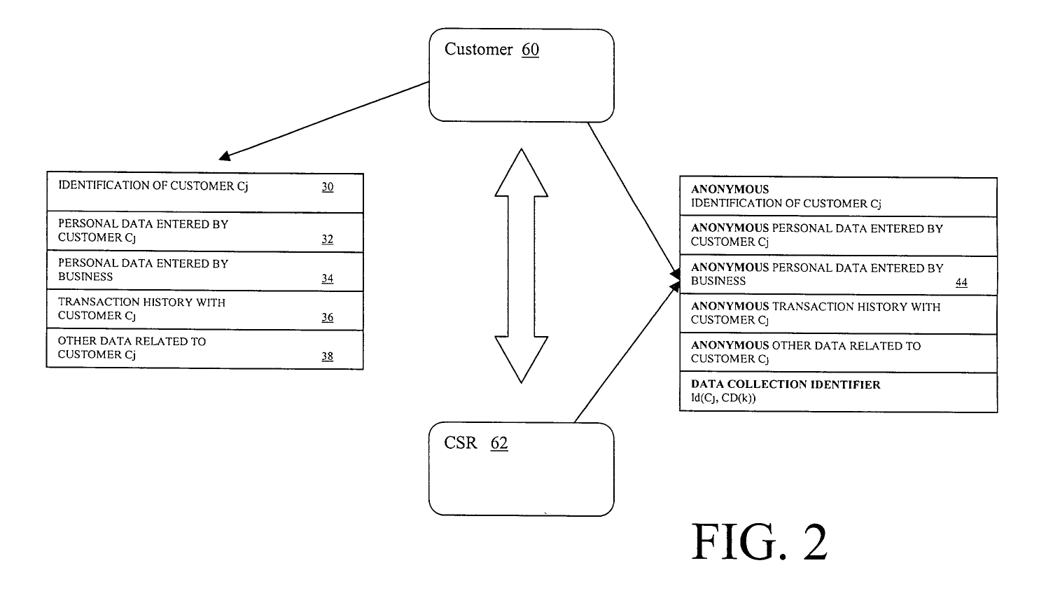

Referring now to FIG. 2, an exemplary embodiment involving a customer 60 in communication with a CSR 62 is shown. Customer 60 can view all of his or her customer specific data, e.g., a customer identification 30, personal data entered by the customer 32, personal data entered by the business 34, transaction history 36, and other data 38. Customer 60 can also view the special subset of data defined by Id(Cj, CD(k)), which in this case comprises anonymous personal data entered by the business 44. CSR 62 only has a view of the special subset defined by Id(Cj,CD(k)). During the interaction with one or more human and/or machine CSR's, customer 60 may create/release new chunks of anonymous data, which may be prepared according to new privacy standards that the customer 60 adopts while engaged in problem solving discussions with the CSR set. Thus, for instance, as the confidence in the business that customer 60 deals with increases or decreases during the interaction, customer 60 can dynamically change the subset of viewable data.

It is understood that the systems, functions, mechanisms, methods, and modules described herein can be implemented in hardware, software, or a combination of hardware and software. They may be implemented by any type of computer system or other apparatus adapted for carrying out the methods described herein. A typical combination of hardware and software could be a general-purpose computer system with a computer program that, when loaded and executed, controls the computer system such that it carries out the methods described herein. Alternatively, a specific use computer, containing specialized hardware for carrying out one or more of the functional tasks of the invention could be utilized. An example is a secure coprocessor such as the IBM 4758 PCI Cryptographic Coprocessor, a product used extensively in servers for applications requiring the highest levels of assurance (e.g., banking and financial applications, electronic commerce systems). Pervasive low-end secure coprocessors (e.g., smart cards, secure tokens), used for key storage and user authentication, are also currently available and may provide some security assurances in lieu of more comprehensive devices.

The present invention can also be embedded in a computer program product, which comprises all the features enabling the implementation of the methods and functions described herein, and which—when loaded in a computer system—is able to carry out these methods and functions. Computer program, software program, program, program product, or software, in the present context mean any expression, in any language, code or notation, of a set of instructions intended to cause a system having an information processing capability to perform a particular function either directly or after either or both of the following: (a) conversion to another language, code or notation; and/or (b) reproduction in a different material form.

The foregoing description of the preferred embodiments of the invention have been presented for purposes of illustration and description. They are not intended to be exhaustive or to limit the invention to the precise form disclosed, and obviously many modifications and variations are possible in light of the above teachings. Such modifications and variations that are apparent to a person skilled in the art are intended to be included within the scope of this invention as defined by the accompanying claims.

1. A customer relationship management (CRM) system, comprising:
a database for storing customer data;
a customer interface for allowing a customer to access customer specific data;
a data disclosure management system for allowing the customer to identify a subset of the customer specific data that can be disclosed to a third party; and
a third party interface for allowing a third party to access the subset of customer specific data.

2. The CRM system of claim 1, wherein the subset of customer specific data is kept anonymous to the third party by the data disclosure management system.

3. The CRM system of claim 1, wherein the data disclosure management system allows the customer to dynamically change the subset of customer specific data during an interaction between the customer and the third party.

4. The CRM system of claim 1, wherein the data disclosure management system includes a mechanism for allowing the customer to create a subset identifier that includes a customer identifier and a context descriptor.

5. The CRM system of claim 4, wherein the data disclosure management system includes a mechanism for granting access to the third party based on the subset identifier.

6. The CRM system of claim 5, wherein the mechanism for granting access to the third party is further based on a privacy policy of the customer.

7. The CRM system of claim 5, wherein the mechanism for granting access to the third party is further based on a set of context rules.

8. The CRM system of claim 1, wherein each of the customer interface and the third party interface comprises a security system selected from the group consisting of a secure coprocessor, secure software, secure protocols, and a cryptographic algorithm.

9. The CRM system of claim 1, wherein the customer interface includes a disagreement system that allows a customer to disagree with a portion of the customer specific data.

10. The CRM system of claim 1, wherein the customer specific data comprises a transaction history.

11. The CRM system of claim 1, wherein the third party is a customer service representative.

12. The system of claim 1, wherein the database is under the direct control of an entity selected from the group consisting of the customer, a business and a trusted entity.

13. A customer relationship management (CRM) system residing on a server that is accessible by a plurality of customers of a business and a customer service representative (CSR) of the business, comprising:
a database for storing data for each of the plurality of customers related to interactions with the business;
a customer interface that allows each customer to access customer specific data;
a data subset identification system that allows the customer to identify a subset of the customer specific data; and
a CSR interface that allows the CSR to view only the identified subset of customer specific data.

14. The CRM system of claim 13, wherein the customer interface includes a system for allowing a customer to edit portions of the customer specific data.

15. The CRM system of claim 13, wherein the customer interface includes a system for allowing a customer to post a disagreement with a portion of the customer specific data.

16. The CRM system of claim 13, wherein the data subset identification system includes a mechanism for creating an identifier that includes an identify of the customer and a descriptor value.

17. The CRM system of claim 14, further including a third party access system that controls access by the CSR based on the identifier, a privacy policy of the customer, and a set of context rules.

18. A customer relationship management (CRM) method, comprising:
providing a database of customer data that is accessible by a plurality of customers of a business and a customer service representative (CSR) of the business;
initiating a communication between a customer and the CSR to resolve a customer issue;
securely outputting customer specific data to the customer;
defining a subset of the customer specific data that the customer wants to release to the CSR to further resolve the customer issue; and
securely outputting the subset of customer specific data to the CSR.

19. The CRM method of claim 18, wherein the communication between the customer and the CSR comprises a telephone call.

20. The CRM method of claim 18, comprising the further step of, during the communication, redefining the subset of the customer specific data that the customer wants to release to the CSR.

21. The CRM method of claim 18, wherein the subset of customer specific data does not reveal the identity of the customer.
